(19) United States
(12) Patent Application Publication
(10) Pub. No.: US 2008/0101798 A1
(43) Pub. Date: May 1, 2008

(54) Communication by radio waves and optical waveguides

(76) Inventors: Peter Healey, Suffolk (GB); Paul David Townsend, Ovens (IE); Colin William Ford, Martlesham Heath (GB)

Correspondence Address: CORNING INCORPORATED, SP-TI-3-1, CORNING, NY, 14831, US

(21) Appl. No.: 11/985,488

(22) Filed: Nov. 15, 2007

Related U.S. Application Data
(63) Continuation of application No. 10/966,509, filed on Oct. 15, 2004, now abandoned.

(51) Int. Cl. H04B 10/00

(52) U.S. Cl. 398/115

(57) ABSTRACT

The invention relates to improvements to full-duplex bi-directional opto-electrical transducers, primarily for use in radio-over-fiber installations, such as remote-antenna installations for cellular radio apparatus. The transducer is of the kind based on an electroabsorption modulator, and the first improvement consists in biasing it by means of a constant-current source rather than conventionally by directly setting a bias voltage. With appropriate selection of the EAM, a preset constant current source is considered adequate, but its setting may be adjusted to operating conditions by a control algorithm if found desirable. A second improvement consists in increasing the effective load impedance of the EAM by using an inductive load that forms a tuned circuit with the internal capacitance of the EAM, resonant at a frequency in the operating range.

### BACKGROUND OF THE INVENTION

1. Field of the Invention

This invention relates to the field of communications, and in particular to transducers for and methods of converting radio signals, via electrical signals, to optical signals in fibers or other waveguides and vice versa. It is mainly, but not exclusively, of application to so-called “radio-over-fiber” techniques for remote antennas in cellular radio systems, most especially cell phone systems; and certain aspects of the invention are useful in “picocell” antenna installations that are passive in the sense that they operate without needing local electrical power.

2. Description of the Related Art

Effective coverage for cellphone or other cellular radio systems demands large numbers of antennas, some of them in remote positions, and there are substantial savings to be made in the cost of provision and maintenance if the electrical power requirement at the antenna site can be reduced, say to the level that can be efficiently supplied by a small solar cell, or in favorable cases eliminated entirely.

It is known that “radio-over-fiber” systems in which signal is conducted to and from the antenna site by an optical fiber can use a single electro-absorption modulator (EAM) as a bi-directional (full duplex) electro-optical transducer and that in some cases sufficient signal strength can be achieved in both directions without amplification, that is with the transducer connected passively to transmitting and receiving antennas. Mostly, appropriate biasing is needed to achieve satisfactory performance in both directions, but in very small cells a zero bias may give acceptable performance. Such cells, sometimes called picocells, may serve a compact area of high demand (for example an airport lounge or like enclosed space).

There is a need in installations of this kind for a technique that enables efficient control of conversion efficiencies simultaneously in both directions.

There is also a need for increasing conversion efficiency by reducing undesirable effects of the capacitance of the EAM.

### BRIEF SUMMARY OF THE INVENTION

One aspect of our invention is the use of a constant-current source to bias the EAM. This automatically sets a substantially fixed downstream electrical (RF) signal level, and allows the upstream modulation efficiency to be adjusted remotely (from the base station), simply by adjusting the optical power level. The technique also allows the point of minimum intermodulation distortion (IMD) to be controlled, if desired, from the base station, where it is relatively easy to monitor.

Thus one aspect of our invention is a transducer for converting a radio signal, via an electrical signal, to an optical signal in a waveguide and vice versa and comprising an electroabsorption modulator optically coupled, either directly or indirectly, to said waveguide, at least one antenna electrically coupled to said electroabsorption modulator, and an electrical constant-current source coupled to said electroabsorption modulator to bias it.

The invention includes a radio-over-fiber installation comprising a remote antenna unit in the form of the transducer described in the preceding paragraph and a base station comprising a source of downstream optical signal, a detector for upstream optical signals and an amplitude controller for optimizing the operation of said transducer by adjustment of its optical input amplitude.

Another aspect of our invention is to use a parallel tuned circuit to increase the effective load impedance of the EAM by countering the effect of its capacitance.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE SEVERAL VIEWS OF THE DRAWINGS

In the drawings:

FIG. 1 is a graph illustrating the characteristics of a typical EAM;

FIG. 2 is a simplified circuit diagram of an EAM biased according to our invention;

FIG. 3 is a Thevenin equivalent circuit of the apparatus of FIG. 2;

FIG. 4 is a graph showing the performance of an EAM biased in accordance with the invention as a function of temperature;

FIG. 5 is a graph showing the performance of the same EAM at a range of input optical power levels;

FIG. 6 is a supplementary graph showing the electrical output power as a function of bias voltage, under the same constant-current conditions;

FIGS. 7-9 show circuit diagrams of respective EAM transducers in accordance with the invention;

FIG. 10 is a graph, generally similar to FIG. 1, illustrating characteristics of a type of EAM used in relation to the transducers of FIGS. 6-9; and

FIG. 11 is a diagram of a transceiver installation including a transducer according to the invention.

### DETAILED DESCRIPTION OF THE INVENTION

Reference will now be made in detail to the present preferred embodiments of the invention, examples of which are illustrated in the accompanying drawings. Whenever possible, the same reference numerals will be used throughout the drawings to refer to the same or like parts.

Theoretical Treatment of Constant-Current Biasing

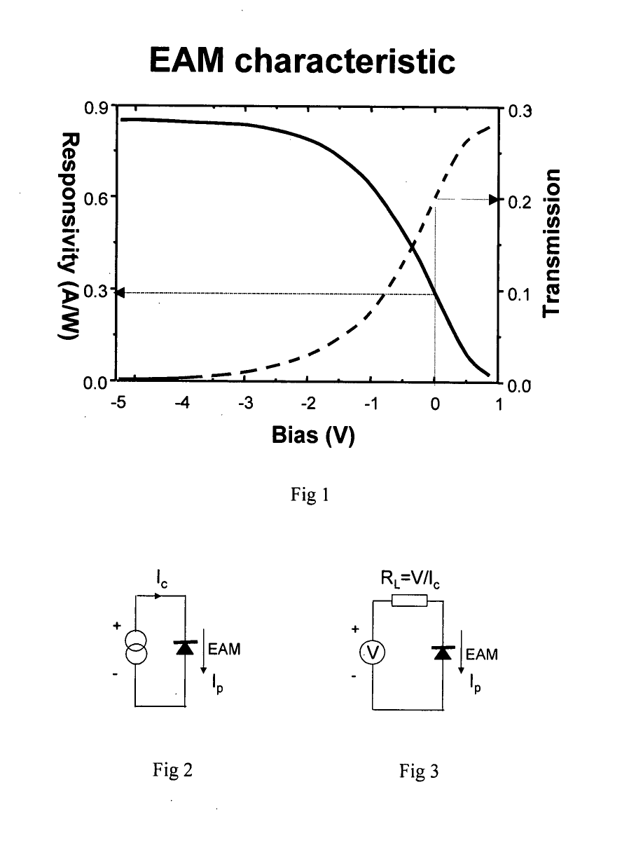

In the graph of FIG. 1, the solid curve represents the measured DC responsivity (electrical direct current output per unit optical power input) of a typical EAM, as a function of reverse DC bias voltage; the dashed curve represents fraction of light transmitted and is in close inverse relation to it, since the charge-pairs that give rise to output current are proportionally generated by absorption of photons. The RF modulation efficiency (and so upstream signal strength, “upstream” meaning in the direction from antenna to base station and so involving conversion of electrical to optical signals) is determined by the slope of the transmission curve at the operating bias.

FIG. 2 simply represents an EAM biased not with a fixed bias voltage but with a constant-current source. Such sources are well-known in the electrical arts and need not be described in detail. Inevitably the photocurrent Iₚ of the EAM must be equal to the imposed bias current I_{c}; as can be deduced, or at least accounted for, by consideration of the Thevenin equivalent circuit shown in FIG. 3. If the photocurrent were to exceed the imposed current, then there would be a greater voltage drop across the equivalent resistance R_{L} and that would reduce the bias voltage and so the photocurrent; and inversely if it were to be less than the imposed current. Thus the EAM absorption, and its responsivity, must automatically adjust so as to balance I_{c}=Iₚ=ηPₐ, where Pₐ is the absorbed power. Provided the modulation depth of the input light signal is constant, it follows that the RF signal generated by the EAM will be of constant amplitude. Provided the working range of the constant-current source is not exceeded, this remains true for a wide range of ambient temperatures, input light levels, input wavelengths and polarization states.

It will be realized that the optical power usefully absorbed in the EAM, Pₐ, is equal to Rg_{c}Pᵢ, where R is the absorption coefficient of its active region at a given bias voltage, Pᵢ is the incident optical power and g_{c} is the proportion of incident light reaching the active part of the device through the coupling region at its light-entry end. The ideal responsivity in amps per watt (neglecting losses) would be ηR, where η is a wavelength-dependant parameter with a value close to 1.25 at a typical telecommunications wavelength of 1550 nm. Thus the light transmission through the active part of the device T=1−R=1−I_{c}/(ηg_{c}Pᵢ). So it follows that T (or R) can be chosen at will, within limits, by adjustment of Pᵢ. It may clarify this to note that FIG. 1, as already described, shows an external circuit measurement of responsivity versus DC bias voltage for a typical EAM. As can be seen, when the bias is close to −5V, very little light is transmitted because the voltage-dependent absorption coefficient is at its maximum value. The externally measured responsivity has a maximum value of just below 0.9 A/W. This corresponds to:

$$\frac{{I}_{p}}{{P}_{i}} = \frac{η {Rg}_{c} {P}_{i}}{{P}_{i}} = η {Rg}_{c}$$

Corresponding Experiments

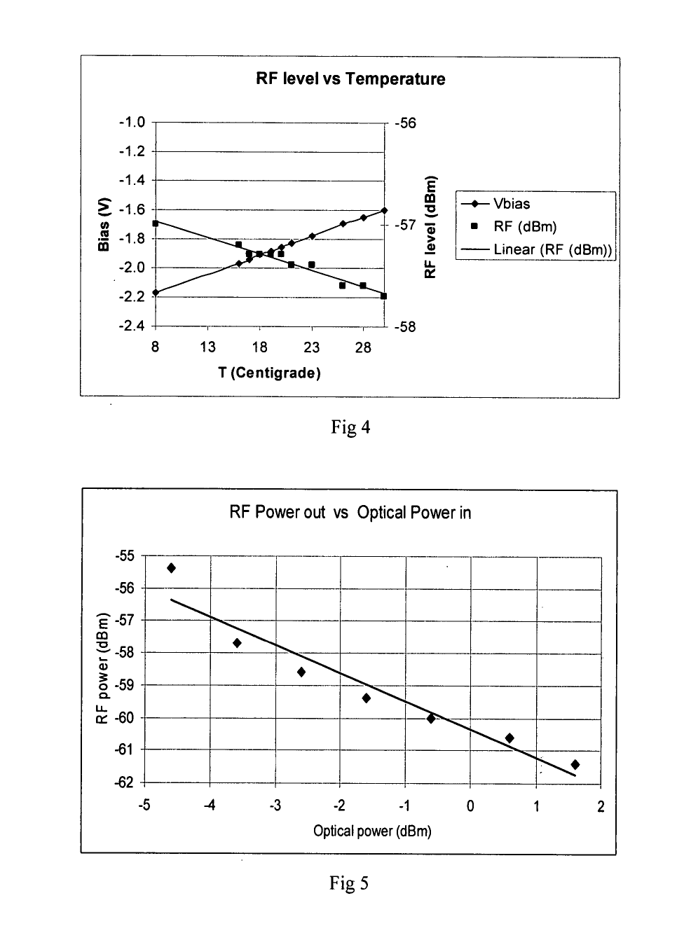

Experimental results show some small but not always negligible systematic departures from the predictions of this simple theory, which the applicants (without wishing to be bound by any theory) believe to be due to variations in the frequency response of the EAM with bias voltage, attributable to differences in the characteristic transport times of electrons and holes, but that does not detract from the usefulness of the invention. By way of example, the EAM used to generate the curves of FIG. 1, which was of an early design in which no account had been taken of this effect, was biased with a constant-current source of 0.22 mA and its electrical output and bias voltage measured as a function of temperature over the range from 8 to 30° C. The results are graphed in FIG. 4, and show that the output was constant within about 0.7 dB, but did vary in a closely linear manner with the bias voltage.

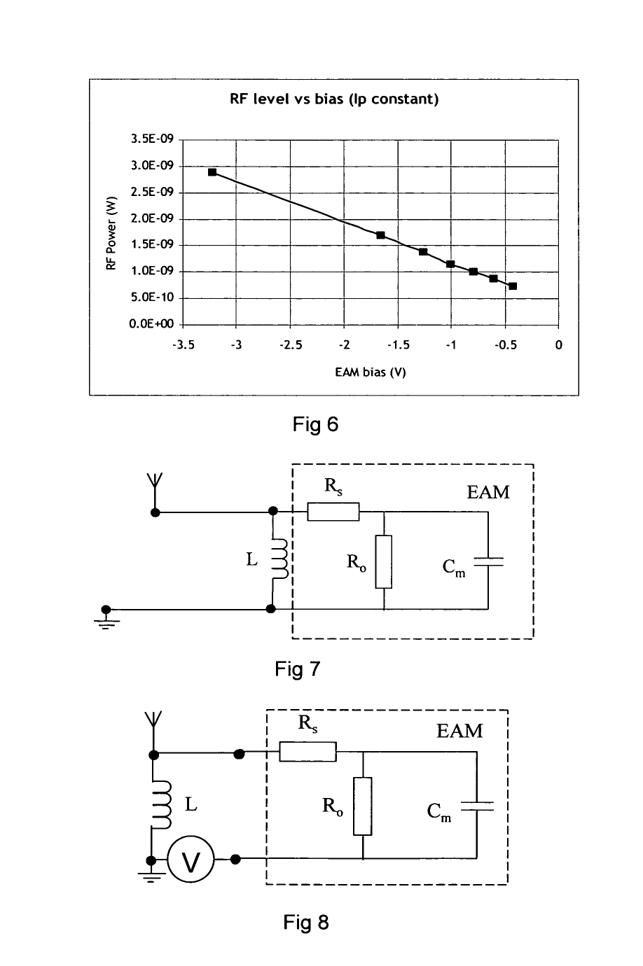

FIGS. 5 and 6 show the response of this EAM, under the same constant-current bias conditions, over a range of input optical power levels, and show that over the measured range (which corresponds to the most attractive, steepest, part of the EAM transfer characteristic) electrical power output increased by approximately 1 dB for each dB of reduction in the optical input power. FIG. 6 illustrates how this effect is remarkably linear in relation to the bias voltage. These variations are relatively small, and do not detract from the usefulness of the invention; if necessary, they can be allowed for in a control algorithm—It is believed that with appropriate selection of the EAM, a preset constant current will be adequate for practical purposes; but even if (for a particular EAM design) it proves necessary to utilize a look-up table or other computation to determine the optimum bias current for present operating conditions, that would be a much simpler look-up table than one designed to define the optimum bias voltage directly.

Another factor influencing the modulation efficiency of and EAM in this type of system, because it is a voltage-driven device, is its load impedance, generally in the sense that higher load impedance will lead to higher efficiency and greater radio range, with the important proviso that in passive (no applied bias) mode, the voltage developed must not be so large as to move out of the substantially linear part of the response curve.

It does not necessarily follow that just connecting a higher resistance to the EAM will achieve a usefully increased efficiency, because the EAM itself has a substantial capacitance and so, at radio frequency, provides a relatively low impedance shunt. Another aspect of our invention is to reduce, and where possible substantially eliminate, this shunting effect by forming with the internal capacitance of the EAM a parallel tuned circuit that is resonant at a frequency in the operating range of the transducer. FIGS. 7-9 each illustrate one way of doing this.

FIG. 7 represents a “passive picocell” installation, that is one without any amplification or bias and so requiring no electrical power. The EAM (shaded rectangle) is represented by its electrical equivalent circuit comprising series resistance R_{S}, capacitance Cₘ and dynamic photo-resistance R₀, by which is meant the reciprocal of Pᵢ.∂R(V)/∂V, where Pᵢ is the incident optical power and ∂R(V)/∂V is the slope of the EAM responsivity vs bias voltage curve (This curve will be further discussed later). In accordance with the invention, the external load is an inductance L chosen to form with Cₘ a parallel tuned circuit resonant in (preferably at or near the middle of) the working frequency range of the transducer, typically in the range 1-100 GHz and for example at 2.4 or 5.2 GHz for use in wireless local area networks, or 2 GHz for the “G3” cellphone network; the only other essential component is an antenna, though there will often be a feeder and an antenna matching unit. For typical device and installation parameters (principally coupling loss, responsivity and expected light levels), the maximum photocurrent at zero bias is likely to be of the order of 1 mA, thus giving rise to a peak forward voltage of around 0.05 V in a 50Ω load impedance, compared with an open-circuit value of around 0.6 V. At 0.05 V, the response should be substantially linear, whereas at open circuit a substantially logarithmic response is expected; the load impedance value at which non-linearity becomes unacceptable will vary from device to device and is anyway partly subjective; experts in the art will be able to determine and achieve the best impedance value for any particular EAM.

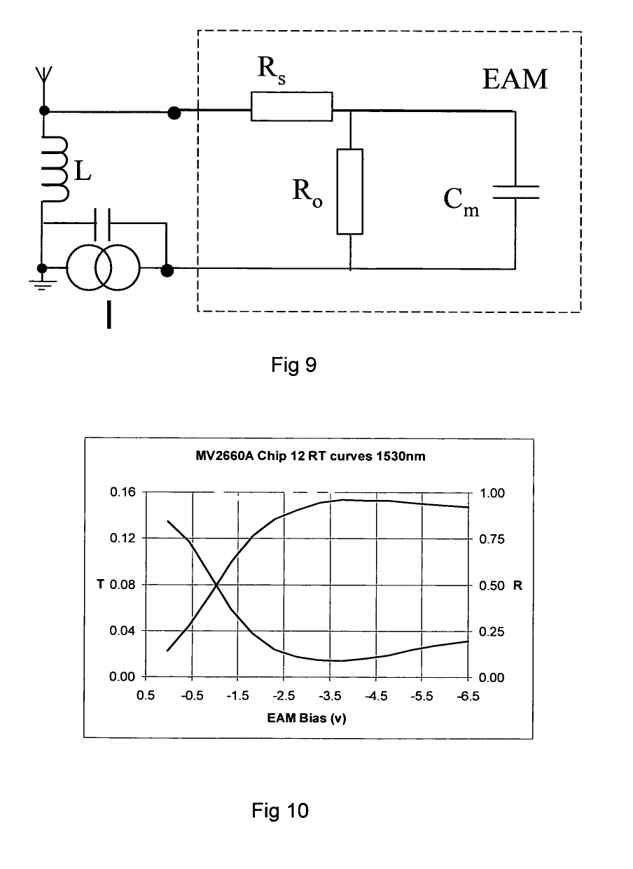

No such limitation arises when the EAM is duly biased; FIG. 8 shows a conventional set-voltage biasing arrangement, and FIG. 9 a constant-current biasing arrangement according to our invention. In either case, the Q-factor of the tuned circuit can be tailored to a required signal modulation bandwidth, subject to limitations set by the inherent series resistance R_{S} and the dynamic photo-resistance R₀.

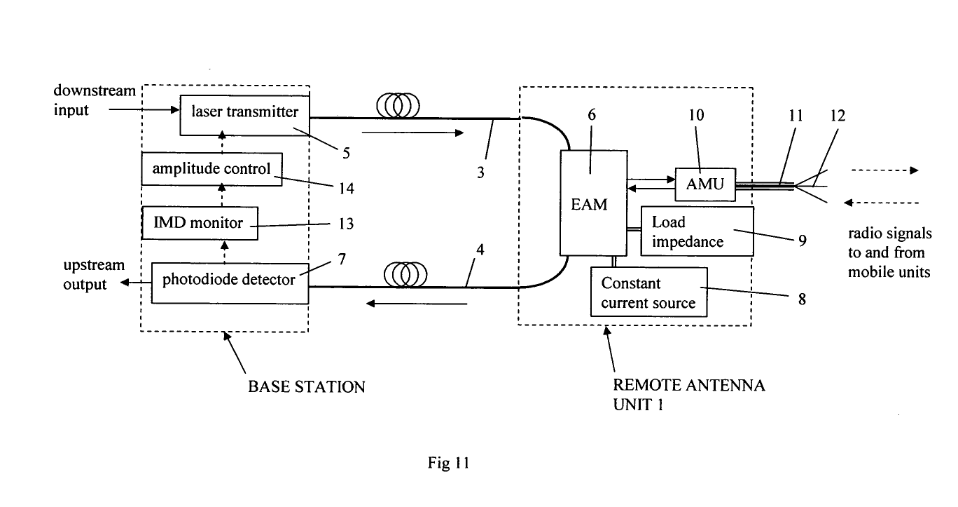

FIG. 10 shows the characteristic curves for a specific EAM that was used in simulations in relation to this aspect of the invention. Note that it corresponds in general terms to FIG. 1 but that the direction of plotting is reversed and the vertical axes are labeled the opposite way around. At zero bias, the slope of the responsivity vs bias voltage curve is about +0.25 and for Pᵢ=2.5 mW, R₀ would be about 1.33 kΩ. R₀ is inversely proportional to Pᵢ, so the Q-factor of the tuned circuit will fall with increasing incident optical power.

FIG. 11 exemplifies the transducer of the invention in context as a remote antenna unit 1 of a radio-over-fiber installation. It is connected to a base station 2 by two optical fibers 3 and 4 which conduct optical signals respectively from a laser transmitter 5 in the base station to the optical input side of the EAM 6 and from the optical output side of the EAM 6 to a photodetector 7 in the base station. Constant-current source 8 and inductive load impedance 9 are connected to the EAM 6 as previously described, and its electrical signal ports are connected via an antenna matching unit 10, which may be integrated with the load impedance 9, and a feeder 11 to a bi-directional antenna 12, assumed to be a dipole in which case a ground connection is optional. Note that the antenna matching unit may not match the impedances of the EAM and antenna in the narrow sense of equalizing them for optimum power transfer, since it may be more importance to achieve a relatively high voltage level than to transfer power efficiently. In the base station 2, a part of the upstream signal is used as input to an intermodulation distortion monitor 13 which in turn provides' an input (not necessarily the only input) to an amplitude control 14 which adjusts the amplitude of the output from the laser 5 to set the EAM bias point to ensure sufficient upstream radio-frequency signal power and low intermodulation distortion, and generally to optimize the installation according to current operating conditions.

Simulation using the commercial microwave simulation software “DragonWave 7.0™”, confirmed by experiment, indicate that a Q factor of at least 5 and an effective EAM load impedance of about 250Ω can be achieved with practicable component values, the specific values that are appropriate being a function of the particular EAM, but within the expertise of those skilled in the art to determine. It is noted that reduction of the value of the EAM capacitance Cₘ is beneficial, and that this indicates an advantage in using a reflective EAM, since that allows the optical path length and modulation depth to be maintained while halving the physical length of the device.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

Any discussion of the background to the invention herein is included to explain the context of the invention. Where any document or information is referred to as “known”, it is admitted only that it was known to at least one member of the public somewhere prior to the date of this application. Unless the content of the reference otherwise clearly indicates, no admission is made that such knowledge was expressed in a printed publication, nor that it was available to the public or to experts in the art to which the invention relates in the US or in any particular country (whether a member-state of the PCT or not), nor that it was known or disclosed before the invention was made or prior to any claimed date. Further, no admission is made that any document or information forms part of the common general knowledge of the art either on a world-wide basis or in any country and it is not believed that any of it does so.

1. A transducer for converting a radio signal, via an electrical signal, to an optical signal in a waveguide and vice versa comprising an electroabsorption modulator optically coupled to said waveguide, at least one antenna electrically coupled to said electroabsorption modulator, and an electrical constant-current source coupled to said electroabsorption modulator to bias it.

2. The transducer of claim 1 further comprising a computer controlled by an algorithm responsive to operating conditions to adjust said constant-current source.

3. A transducer for converting radio signals, via electrical signals, to optical signals in waveguides and vice versa comprising an electroabsorption modulator having an internal capacitance optically coupled to said waveguide, at least one antenna electrically coupled to said electroabsorption modulator and a load impedance connected to said electroabsorption modulator wherein said load impedance is inductive and forms with said internal capacitance a parallel tuned circuit.

4. The transducer of claim 3 in which said tuned circuit is resonant at a frequency in the range 1-100 GHz.

5. The transducer of claim 3 in which said tuned circuit is resonant at a frequency of about 2 GHz.

6. The transducer of claim 3 in which said tuned circuit is resonant at a frequency of about 2.4 GHz.

7. The transducer of claim 3 in which said tuned circuit is resonant at a frequency of about 5.2 GHz.

8. The transducer of claim 3 in which said tuned circuit defines a load impedance of about 250Ω at its tuned frequency.

9. The transducer of claim 3 further comprising an electrical constant-current source coupled to said electroabsorption modulator to bias it.

10. The transducer of claim 3 in which said electroabsorption modulator is of the reflection type.

11. A method of converting radio signals, via electrical signals, to optical signals in waveguides and vice versa comprising coupling an electroabsorption modulator optically to said waveguide, coupling at least one antenna electrically to said electroabsorption modulator, and biasing said electroabsorption modulator by means of an electrical constant-current source.

12. The method of claim 11 comprising adjusting said constant-current source according to an algorithm responsive to operating conditions.

13. The method of claim 11 comprising remotely optimizing the operation of said electroabsorption monitor by adjustment of the amplitude of its optical input.

14. A radio-over-fiber installation comprising:
a remote antenna unit comprising the transducer of claim 1 and
a base station comprising a source of downstream optical signal, a detector for upstream optical signals and an amplitude controller for optimizing the operation of said transducer by adjustment of its optical input amplitude.

15. A method of converting radio signals, via electrical signals, to optical signals in waveguides and vice versa comprising optically coupling to said waveguide an electroabsorption modulator having an internal capacitance, electrically coupling at least one antenna to said electroabsorption modulator and connecting an inductive load impedance to said electroabsorption modulator to form with said internal capacitance a parallel tuned circuit.

16. The method of claim 15 comprising tuning said tuned circuit to a frequency in the range 1-100 GHz.

17. The method of claim 15 comprising tuning said tuned circuit to a frequency of 2 GHz.

18. The method of claim 15 comprising tuning said tuned circuit to a frequency of 2.4 GHz.

19. The method of claim 15 comprising tuning said tuned circuit to a frequency of 5.2 GHz.

20. The method of claim 15 comprising choosing component values for said tuned circuit so that it defines a load impedance of about 250Ω at its tuned frequency.

21. The method of claim 13 further comprising biasing said electroabsorption modulator by means of an electrical constant-current source.
